(19) United States
(12) Patent Application Publication
(10) Pub. No.: US 2006/0013921 A1
(43) Pub. Date: Jan. 19, 2006

(54) Calcium phosphate base particulate compound, process for producing the same and composition comprising the compound

(76) Inventors: Hidemitsu Kasahara, Hyogo (JP); Mitsunobu Aoyama, Hyogo (JP); Hidetake Yoshino, Hyogo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/537,376

(22) PCT Filed: Dec. 4, 2003
(86) PCT No.: PCT/JP03/15512

§ 371 Date: Jun. 3, 2005

(30) Foreign Application Priority Data
Dec. 4, 2002 (JP) 2002-352137

(51) Int. Cl. A23K 1/175

(52) U.S. Cl. 426/74

(57) ABSTRACT

A calcium phosphate base particulate compound is provided which satisfies (a) 20≦Sw≦300 (BET specific surface area (m²/g); (b) 1≦Tg≦150 (heat loss (mg/g) per 1 g of calcium phosphate from 250 to 500° C.); (c) 0.005≦Dx50≦0.5 (cumulative 50% average diameter (μm) counted from larger particle side based on the observation by TEM); and (d) 1.5≦Dx50/σx≦20 (σx: standard deviation {In(Dx16/Dx50)}) The calcium phosphate base particulate compound of the present invention is excellent not only in particulate evenness and dispersibility but in thermal stability, and gives a resin composition excellent in anti-blocking property, a resin composition excellent in printing suitability, and a food composition such as good taste calcium-enriched milk with less precipitation.

### TECHNICAL FIELD

The present invention relates to a calcium phosphate base particulate compound excellent in particulate dispersibility and thermal stability, its production method, and a composition containing the compound.

A new calcium phosphate base particulate compound obtained in the present invention is useful for functional resin composites such as anti-blocking agents, light scattering agents, reception layer agents for paper manufacturing, sizing agents for paper manufacturing, lightweight agents, dimension stabilizers, plane smoothing agents, and reinforcing agents and also usable for a variety of fields such as pigments for coating materials, cosmetics, ceramic raw materials, toothpastes for dentistry, glass polishing agents, catalysts, medicines, thin films, food (nutrient supplements) and the like. The compound is also expected to be useful for further new applications by combining various uses.

### BACKGROUND ART

As conventional calcium phosphate base compounds, inorganic calcium phosphates such as calcium dihydrogenphosphate (primary calcium phosphate), calcium monohydrogenphosphate (secondary calcium phosphate), tricalcium phosphate (tertiary calcium phosphate), and hydroxyapatite can be exemplified. These compounds have been used mainly for food additives, toothpastes for dentistry, dispersants for suspension polymerization, and biomaterials, however, no advanced particle diameter control has been done for them, and for example, in advanced technological fields of such as resin films and ink-jet coating layer pigments which require particles to have uniformity and dispersibility, compounds with satisfactorily controlled diameter have not been made available yet. As production methods of hydroxyapatite with particularly high stability, Japanese Patent Application Laid-Open Nos. 53-111000 and 61-151010 disclose production methods using hardly soluble calcium phosphates as starting raw materials, however the methods have problems that since hardly soluble inorganic calcium phosphates are used as phosphoric acid source, the energy cost is too high and that the raw material shape tends to remain in the case of producing uniform particles.

To the above-mentioned demands, Japanese Patent Application Laid-Open No. 9-25108 discloses that spherical calcium phosphate having a petaloide shape produced from water-soluble phosphoric acid as a starting raw material has high particulate uniformity and dispersibility and is usable as an additive for anti-blocking agents and a pigment for ink-jet coating layers in resin film fields. However, since the calcium phosphate has a porous structure, it is not necessarily satisfactory in the thermal stability and has a probable of causing yellowing deterioration of resin films containing its particles or separation of its particles owing to void acceleration. Further, with respect to magnetic recording media and thermal transfer recording media for which the resin films are used, it has acceleratedly been promoted to make the films thin and in the present situation, to produce nano-scale particles with a particle size of 0.5 μm or smaller corresponding to such thin films, there is left a problem of particulate uniformity and dispersibility. Particularly, with respect to optical films for liquid crystals which have astonishingly been developed in recent years, various optical characteristic films such as polarizing films, reflection prevention films, brightness improvement films, optical compensation (phase difference) films and the like have been employed and it is strongly desired to develop optical scattering control agents containing nano-particles.

Further, in the case of a pigment for an ink-jet coating layer (a reception layer), although being good in the ink absorption property, the particles are required to be further finer for luster and resolution improvement particularly in coating layer faces for photo-grade.

Meanwhile, because of the tendency of insufficient intake of calcium in eating habits in recent years, food products (nutrient enrichment agents) enriched with calcium have drawn attention and for example, in food markets of milk, yoghurt, beverage and the like, tasteless, odorless, and non-sedimentary finer particulate products have been demanded.

The present invention aims to provide a calcium phosphate base particulate compound excellent in thermal stability and particulate uniformity and dispersibility, which are problems matters to be solved in conventional calcium phosphate compounds.

In view of the above actual circumstances, the present invention provides a calcium phosphate base particulate compound excellent in particulate uniformity and dispersibility and thermal stability, a method of easily and economically producing the compound, and a resin composition and a food composition containing the calcium phosphate base particulate compound.

Inventors of the present invention have made extensive investigations to solve the above-mentioned problems, and have found that a calcium phosphate base particulate compound excellent in uniformity, dispersibility and thermal stability is obtained by carrying out heating treatment at a prescribed temperature after synthesis in a pH range of 5 to 12 and aging for a prescribed duration, and accordingly have completed the present invention.

### DISCLOSURE OF THE INVENTION

That is, the present invention provides, in a first aspect, a calcium phosphate base particulate compound satisfying the following expressions (a) to (d):
20≦Sw≦300 (m²/g); (a)
1≦Tg≦150 (mg/g); (b)
0.005≦Dx50≦0.5 (μm); and (c)
1.5≦Dx50/σx≦20 (d)
wherein,
Sw: BET specific surface area (m²/g) measured by nitrogen adsorption method,
Tg: heat loss (mg/g) per 1 g of calcium phosphate base particulate compound from 30 to 250° C.,
Dx50: cumulative 50% average diameter (μm) counted from larger particle side based on the observation by transmission electron microscope (TEM),
σx: standard deviation {In(Dx16/Dx50)}; and
Dx16: cumulative 84% average diameter (μm) counted from larger particle side based on the observation by transmission electron microscope (TEM).

The present invention provides, in a second aspect, a production method of a calcium phosphate base particulate compound which comprises the steps of:
synthesizing calcium phosphate compound by reaction of a calcium compound and a water-soluble phosphoric acid compound in a pH range of 5 to 12,
aging the obtained calcium phosphate compound for 0.1 to 24 hours, and
heating the obtained calcium phosphate compound at 95 to 180° C.

The present invention provides, in a third aspect, a resin composition obtained by adding the above-mentioned calcium phosphate base particulate compound to a resin.

The present invention provides, in a fourth aspect, a food composition obtained by adding the above-mentioned calcium phosphate base particulate compound to a food product.

### BRIEF DESCRIPTION OF DRAWING

FIG. 1 is a TEM photograph of the powder of the calcium phosphate base particulate compound obtained in Example 1.

### BEST MODES FOR CARRYING OUT THE INVENTION

Hereinafter, the present invention will be described in more detail.

The expression (a) defines BET specific surface area (Sw) of the calcium phosphate base particulate compound of the present invention measured by nitrogen adsorption method and indexes the particle size required to be in a range of 20 to 300 m²/g. If the BET specific surface area (Sw) is lower than 20 m²/g, for example, the particulate compound is added for food additive to beverages, the particulate compound tends to precipitate. On the other hand, if it exceeds 300 m²/g, the particle size is so small as to worsen dispersion stability and results in a problem of thermal stability, which is an aim of the present invention, or a problem of dissolution in the case of suspension of the particulate compound in beverages. Accordingly, it is preferably in a range of 25 to 200 m²/g and more preferably in a range of 30 to 120 m²/g.

The expression (b) numerically expresses the thermal stability of the calcium phosphate base particulate compound of the present invention and the heat loss (Tg) per 1 g of calcium phosphate base particulate compound at a temperature range of from 250 to 500° C. is required to be in a range of 1 to 150 mg/g. If the heat loss (Tg) is lower than 1 mg/g, although the thermal stability of the particles is good, the crystal particulate dispersibility is deteriorated in the case of being minute particles and therefore if the particulate compound is used as a pigment for ink-jet coating layers, adverse effects such as deterioration of image clearness or luster are caused. On the other hand, if it exceeds 150 mg/g, in the case where the particulate compound is used for anti-blocking agents for resin films, the particulate compound accelerates deterioration of the resin and causes yellowing deterioration and void formation. Accordingly, it is preferably in a range of 1 to 100 mg/g and more preferably in a range of 1 to 50 mg/g.

The heat loss (Tg) is calculated by sampling about 100 mg of the calcium phosphate base particulate compound in a sample pan (made of platinum) with 10 mm diameter by TG-8110 model manufactured by Rigaku Corp., measuring the heat loss amount from 250° C. to 500° C. at 15° C./min temperature increase rate, and calculating the heat loss ratio (mg/g) per 1 g of the calcium phosphate base particulate compound.

The expression (c) defines the average diameter of the calcium phosphate base particulate compound of the present invention calculated from the diameter observed by a transmission electron microscope (TEM). Practically, after the particles are photographed and observed by TEM, a work of reading the longer diameter parts (the maximum diameter in a specified direction) of respective particles (the number of sampled particles is 100) is carried out by a coordinate reading apparatus (a digitizer) and it is required that the calculated average particle diameter (Dx50) is in a range of 0.005 to 0.5 μm. If the Dx50 is lower than 0.005 μm, as described above, the particles are too small to satisfy the aim of the present invention or to be used for the purposes of the present invention. On the other hand, if it exceeds 0.5 μm, the particle diameter is too large to satisfy the aim of the present invention or to be used for the purposes of the present invention. Accordingly, it is preferably in a range of 0.01 to 0.3 μm and more preferably in a range of 0.01 to 0.2 μm. The shape of the particles is not particularly limited and spherical, hexagonal platy, cubic, needle-like, rod-like, and pillar shapes can be exemplified and selectively used depending on the uses.

The expression (d) expresses the value obtained by dividing Dx50 calculated as the TEM diameter by σx (standard deviation). If the Dx50/σx is lower than 1.5, the particle uniformity is insufficient and therefore, it is not suitable for the aim and uses of the present invention. On the other hand, if it exceeds 20, the particle shape is limited to the true spherical shape and therefore, it is preferably in a range of 2 to 20 and more preferably in a range of 2.5 to 20.

The calcium phosphate base particulate compound of the present invention is preferable to satisfy expressions (e) and (D other than the above-mentioned expressions (a) to (d).

The expression (e) numerically expresses the gap from the photographic diameter based on the comparison of the dispersibility of the particles of the calcium phosphate base particulate compound of the present invention in a suspension system actually measured by an analyzer and the α-value obtained by dividing the average particle diameter (Dxs50) calculated using a particle size distribution measurement apparatus by the average particle diameter (Dx50) calculated using TEM is preferably in a range of 0.5 to 5. If the a exceeds 5, the particulate dispersibility is insufficient and the particles cannot be used for the aim and uses of the present invention in some cases. Accordingly, it is more preferably in a range of 0.5 to 4 and even more preferably in a range of 0.5 to 3.

The expression (f) numerically expresses the gap from the photographic diameter based on the comparison of the uniformity of the particles of the calcium phosphate base particulate compound of the present invention in a suspension system actually measured by an analyzer, and the D-value calculated using a particle size distribution measurement apparatus is preferably in a range of 0 to 3. If the β exceeds 3, the particulate uniformity is insufficient and the particles cannot be used for the aim and uses of the present invention in some cases. Accordingly, it is more preferably in a range of 0 to 2.5 and even more preferably in a range of 0 to 2.

The particle size distribution in the expressions (e) and (i) is measured by weighing the following mixing materials (I) and (II) in a 140 ml mayonnaise bottle, preliminarily dispersing the materials by an ultrasonic dispersing apparatus, and subjecting the obtained dispersed mixture as a sample to the measurement by a laser diffraction type particle size distribution apparatus (SALD-2000, manufactured by Shimadzu Corporation).
(I) Calcium phosphate base particulate compound solid matter of the present invention 2.0 g, and
(II) Water 40 g.

Especially, it is preferable to carry out the ultrasonic dispersion to be employed for the preliminary dispersion in prescribed condition and in the present invention, US-300T (manufactured by Nippon Seiki Seisakusho Co., Ltd.) is used as the ultrasonic dispersing apparatus and preliminary dispersion is carried out in the prescribed condition for 60 seconds at 300 μA electric current.

The calcium phosphate base particulate compound of the present invention is more preferable to further satisfy the expressions (g) and (h).

The expression (g) numerically expresses a powder physical property of the particles of the calcium phosphate base particulate compound of the present invention. It is the average fine pore diameter (Dxp) based on the maximum value (Dyp) of the mercury pressure penetration in the fine pore distribution in a range of 0.005 to 0.5 μm measured by mercury pressure penetration method (porosimeter) and means the fineness of the spaces among the particles of the calcium phosphate base particulate compound. It is not the fineness of the particles shown by the (nitrogen) gas adsorption method in the expression (a) but means the dispersibility of secondary particulate diameter and it is preferable in a range of 0.005 to 0.5 μm. If the average fine pore diameter is smaller than 0.005 μm, the primary particles or the secondary particles are so fine that the stability with the lapse of time or the thermal stability could be a problem. If it exceeds 0.5 μm, the particulate dispersibility or the particle diameter is too large to use for the aim and uses of the present invention in some cases. Accordingly, it is more preferably in a range of 0.007 to 0.1 μm and even more preferably in a range of 0.01 to 0.05 μm.

The expression (h) defines an index showing the number of the average fine pore diameter expressed by the expression (g). As described above, since the fine pore capacity becomes smaller as the fine pore diameter becomes smaller, a preferable fine pore diameter amount (number) in the present invention can be indicated as an index by taking the maximum mercury pressure penetration amount (Dyp) and the average fine pore diameter (Dxp) defined by the expression (g) into consideration. The average fine pore diameter amount (Dyp/Dxp) preferable in the present invention is in a range of 20 to 200. If the Dyp/Dxp is less than 20, the average fine pore diameter is so large as to easily cause problems in the uniformity and the dispersibility of the particles and to make dispersion in a resin composition difficult. If it exceeds 200, since the average fine pore diameter is so extremely small, stability of the primary particles or the secondary particles with the lapse of time tends to be a problem. Accordingly, it is more preferably in a range of 30 to 200 and even more preferably in a range of 40 to 200.

It is also effective to add a proper non-metallic ion in order to improve the dispersibility of the particles. If a proper non-metallic ion is added, it is also effective to improve the stability of the surface of the particles. As the proper non-metallic ion, those which have larger atomic radius than that of calcium ion and smaller atomic radius than that of phosphorus ion are preferable and practically chlorine ion is preferable. The content of the non-metallic ion is not particularly limited and generally 10 to 50,000 ppm. If it is less than 10 ppm, the above-mentioned effect to improve the dispersibility and stability is hardly obtained and if it exceeds 50,000 ppm, a problem occurs in the aspect of thermal stability and consequently it becomes difficult to obtain particles with excellent thermal stability, which is the aim of the present invention. Accordingly, it is more preferably in a range of 30 to 30,000 ppm and even more preferably 50 to 10,000 ppm. The content of the non-metallic ion can be adjusted by adjusting, for example, the raw material to be used or the size (Sw) of the particulate diameter. Accordingly, particularly in the case a chlorine type raw material is used and the specific surface area of the particles of the present invention is higher, the content of the non-metallic ion can be increased. The word “content” includes the both amounts of chemical adsorption and physical adsorption.

The crystalline state of the calcium phosphate base particulate compound of the present invention is not particularly limited and examples may include amorphous calcium phosphate (abbreviated as ACP; formula Ca₃(PO₄)₂.nH₂O), fluoroapatite (abbreviated as FAP; formula Ca₁₀(PO₄)₆F₂), chloroapatite (abbreviated as CAP; formula Ca₁₀(PO₄)₆.Cl₂), hydroxyapatite (abbreviated as HAP; formula Ca₁₀(PO₄)₆(OH)₂), octacalcium phosphate (abbreviated as OCP; formula Ca₈H₂(PO₄)₆.5H₂O), tricalcium phosphate (abbreviated as TCP; formula Ca₃(PO₄)₂), calcium hydrogen phosphate (abbreviated as DCP; formula CaHPO₄), and hydrogen calcium phosphate dihydrate (abbreviated as DCPD; formula CaHPO₄.2H₂O), calcium diphosphate (Ca₂P₂O₇) and these compounds may be used singly or in combination of two or more. Among them, in terms of high stability in form of a composition, hydroxyapatite is preferable. The Ca/P ratio of hydroxyapatite is generally in a range of 1.50 to 2.00, preferably in a range of 1.57 to 1.80, and more preferably in a range of 1.62 to 1.72.

To control the particulate diameter of the calcium phosphate base particulate compound of the present invention, for example, a complex forming substance can be used. Examples of complex forming substances usable for the present invention are hydroxycarboxylic acids such as citric acid, malic acid, and oxalic acid; polyhydroxycarboxylic acids such as gluconic acid and tartaric acid; aminopolycarboxylic acids such as iminodiacetic acid, ethylenediamine tetraacetic acid, and nitrilotriacetic acid; amino polycarboxylic acids such as hexametaphosphoric acid and tripolyphosphoric acid; ketones such as acetylacetone, methyl acetoacetate, and allyl acetoacetate; amino acids such as glutamic acid and aspartic acid; inorganic acids such as sulfuric acid, boric acid, phosphoric acid, and hydrofluoric acid; their alkali metal salts, alkaline earth metal salts, and ammonium salts and they may be used singly or in combination of two or more. Among them, in the case of use for food additives, hydroxycarboxylic acid such as citric acid and malic acid can be generally used. In the case of use for additives for resins, inorganic acid such as sulfuric acid and boric acid is preferable in consideration of thermal stability, which is the aim of the present invention.

The content of the complex forming substance is not particularly limited as far as it is such an extent that the content causes no adverse effect on the stability of the particles, which is the aim of the present invention and it is generally in a range of 0.05 to 200% by weight on the basis of the calcium phosphate base particulate compound. If it is less than 0.05% by weight, the effect of the addition is scarcely obtained and on the other hand, if it exceeds 200% by weight, a problem of the stability of the particles tends to be caused. Accordingly, it is more preferably in a range of 0.1 to 100% by weight and even more preferably in a range of 0.5 to 50% by weight.

A production method of the calcium phosphate base particulate compound of the present invention is not particularly limited, however if high temperature (hydrothermal) aging is carried out in alkaline side or acidic side, the particulate dispersibility tends to be easily deteriorated in the alkaline side and problems of the uniformity of the calcium phosphate crystal and the stability of the crystal shape owing to dissolution in an acid tend to be caused in the acidic side. Further, if the heating treatment is carried out at a high pressure range of not lower than 1 Mpa (180° C.), the industrial cost is very much increased. In consideration of the above-mentioned problems, to adjust the dispersibility and uniformity of the particles and the crystal stability, which are aims of the present invention, in industrial scale production method, various production factors may preferably be adjusted.

The preferable adjustment conditions of the calcium phosphate base particulate compound of the present invention are as described below:

(Reaction Conditions)

(1) calcium compound concentration: 1 to 30 (% by weight)
(2) water-soluble phosphoric acid compound concentration: 1 to 30 (% by weight)
(3) reaction temperature: 4 to 50 (° C.)
(4) dropping time: 0.1 to 10 (hours)
(5) stirring blade peripheral speed: 0.5 to 50 (m/s)
(6) pH at the time of phosphorylation: 5 to 12
(7) aging time: 0.1 to 24 (hours)
   (Heating Treatment Conditions)
(8) calcium phosphate base compound concentration: 0.5 to 20 (% by weight)
(9) heating treatment temperature: 95 to 180 (° C.)
(10) heating treatment pH: 5 to 10
(11) heating treatment time: 1 to 48 (hours)
(12) stirring blade peripheral speed: 0.5 to 50 (m/s)

A preferable production method of the calcium phosphate base particulate compound of the present invention will be described in more detail.

(Reaction Conditions)

The calcium compound concentration (1) and the water-soluble phosphoric acid compound concentration (2) are preferable to be 1 to 30% by weight, respectively. As the concentration is higher, the particulate diameter is effectively made smaller and therefore, it is effective to control the diameter. However, if it is lower than 1% by weight, the productivity is low and the cost becomes high and also the particles tend to become large and it is not proper for the particles of the present invention. On the other hand, if it exceeds 30% by weight, the agglomeration of primary particles after the reaction tends to be strong and even if aging and heating treatment are carried out, it becomes difficult to obtain desired dispersibility. Accordingly, it is more preferably in a range 2 to 15% by weight and even more preferably in a range 3 to 12% by weight.

The kind of the calcium compound (1) is not particularly limited unless it is insoluble calcium compounds, and both water-soluble calcium compounds and hardly soluble calcium compounds may be used. Practical examples are calcium chloride, calcium nitrate, calcium acetate, calcium lactate, calcium oxide, calcium hydroxide, calcium oxalate, and calcium bromide and they may by used singly or in combination of two or more.

As the calcium phosphate base compound (2), phosphoric acid and its alkali metal salts and ammonium salt can be exemplified.

In terms of the productivity, it is preferable to carry out the reaction at a molar ratio of (1) and (2) which is not so much deviated from the theoretical ratio of the calcium phosphate production.

The reaction temperature (3) is preferably 4 to 50° C. As the reaction temperature is lower, it is more effective to make the particulate diameter small and therefore, it is effective to control the particulate diameter. However, if the reaction temperature is lower than 4° C., although there is no problem in terms of physical properties, it costs too much and on the other hand, if it exceeds 50° C., a problem on the uniformity and dispersibility of the particles tends to be caused and therefore it is improper in the present invention. Accordingly, it is more preferably in a range 10 to 40° C. and even more preferably in a range of 15 to 35° C.

The dripping time (4) is preferably 0.01 to 10 hours. The dripping time is one of important factors for controlling the shape of the particles. As the dripping time is shorter, it is more effective to make the particulate diameter small, however if the dripping time is short, pH significantly fluctuates to result in deterioration of the crystallinity (thermal stability). Particularly, if the dripping time is shorter than 0.01 hours, it becomes difficult to control pH and the crystallinity of the particles tends to be a problem. On the other hand, if it exceeds 10 hours, although the crystallinity tends to be stable, the particulate diameter becomes too large and the particles are easily agglomerated. Accordingly, it is more preferably in a range 0.1 to 5 hours and even more preferably in a range 0.2 to 3 hours.

Additionally, a dripping method is not particularly limited and may be carried out by dripping the calcium compound (1) to the water-soluble phosphoric acid compound (2) for reaction, and vice versa and a method capable of carrying out phosphorylation reaction in the pH range (6) as described below is preferable.

The stirring blade peripheral speed (5) is one of important factors for particulate diameter control and it is preferable to carry out stirring with a prescribed stirring force or higher. The prescribed stirring force or higher means the stirring force capable of evenly stirring the entire suspension system and as a stirring mechanism, stirring apparatus such as a paddle, a turbine, a propeller, a high speed impeller, and a homo-mixer can be used. Further, a baffle plate is preferable to be installed in a container. The stirring force is generally 0.5 to 50 m/s in the stirring blade peripheral speed. If it is lower than 0.5 m/s, it is difficult to mix and stir a particulate slurry evenly and on the other hand, if it exceeds 50 m/s, it will be problematic to enlarge a reaction apparatus and accordingly, it is preferably in a range of 1 to 30 m/s and even more preferably in a range 3 to 15 m/s.

The pH (6) at the time of phosphorylation is generally preferable to be 5 to 12. In the case of an acidic range with pH lower than 5, not only the yield of the calcium phosphate base particulate compound of the present invention is decreased owing to the solubility of calcium phosphate, but also a desired crystal structure is hardly obtained. On the other hand, in the case the pH exceeds 12, particulate agglomeration is caused by alkalinity and desired dispersibility is hardly obtained. Accordingly, it is more preferably in a pH range of 5.5 to 10 and even more preferably in a pH range of 6 to 9.

The aging (7) means that the obtained particles are kept (aged) as they are after the reaction and the aging time is preferably 0.1 to 24 hours. Execution of aging not only eliminates unreacted remaining ions, but also makes agglomerated particles easy to be dissociated and thus execution of aging before heating treatment is effective. In the case the aging time is shorter than 0.1 hours, sufficient effect can be hardly obtained. If it exceeds 24 hours, the effect is small for time consumption and rather, it may result in high cost. Accordingly, it is more preferably in a range of 0.2 to 12 hours and even more preferably in a range of 0.3 to 10 hours.

(Heating Treatment Conditions)

The heating treatment is carried out to promote crystallization of particles. Particularly, since the particulate surface is disordered more in the crystal lattice and instable as the particles become finer, the particles tend to be dissolved, to be bonded easily and to be agglomerated with other particles. To suppress such tendency, the heating treatment is carried out.

The calcium phosphate base compound concentration (8) is generally preferable to be in a range of 0.5 to 20% by weight. If it is lower than 0.5% by weight, the productivity tends to be low and the cost tends to be high and on the other hand, if it exceeds 20% by weight, dispersion of agglomerated particles is hard to be promoted. Accordingly, it is more preferably in a range of 1 to 15% by weight and even more preferably in a range of 1.2 to 12% by weight.

The heating treatment temperature (9) is preferably 95 to 180° C. If it is lower than 95° C., it tends to take rather long time to increase the crystallinity stability of the surface and it results in a problem in the productivity. On the other hand, if it exceeds 180° C. (1 MPa), a high pressure gas region is produced and it results in an obstacle to enlargement of a reaction tank. Accordingly, it is more preferably in a range of 100 to 170° C. (0.1 to 0.8 MPa) and even more preferably in a range of 120 to 160° C. (0.2 to 0.63 MPa).

The pH (10) of heating treatment is one factor affecting the stability and crystal shape of the particles and it is preferably in a pH range of 5 to 10. If the pH is lower than 5, as described above, an acidic region is produced and the calcium phosphate base particulate compound of the present invention tends to be dissolved to result in a problem in terms of the crystallinity stability and shape. On the other hand, if the pH exceeds 10, an alkaline substance easily adheres to the particulate surface to make it difficult to obtain desired dispersibility. Accordingly, it is more preferably in a pH range of 5.5 to 9.5 and even more preferably in a pH range of 6 to 9.

The heating treatment time (11) is not clearly defined in general since it differs depending on the aging temperature, however it is commonly 1 to 48 hours. If it is shorter than 1 hour, the heating treatment temperature is needed to be high and therefore it is not preferable and on the other hand, if it exceeds 48 hours, the cost tends to be high in terms of the productivity, and rather it is preferable to increase the heating treatment temperature to be higher.

Being different from the case of reaction in which the aim of stirring is to control the particulate diameter or shape, the aim of stirring in this case is to carry out even stirring, and therefore, the stirring blade peripheral speed (12) is generally sufficient in a range of 0.5 to 50 m/s.

After the reaction, aging, and heating treatment are carried out in the above-mentioned manner, it is preferable to remove foreign ions such as alkali metal ions contained in the slurry by filtration and washing with water. The electric conductivity of a filtrate is not particularly limited and generally it is preferably not higher than 1,000 μS/cm, more preferably not higher than 500 μS/cm, and even more preferably not higher than 300 μS/cm.

The method of water washing is not particularly limited and washing with water and concentration may be carried out by using a thickener, an oliver, a rotary filter, a filter press, or the like.

The calcium phosphate base particulate compound of the present invention may be treated (coated) with a surface treatment agent to improve the dispersibility and the stability of the particles.

Although the surface treatment amount is not necessarily clearly defined because it depends on the BET specific surface area defined by the expression (a) and the heat loss (b), it may generally be 0.1 to 50% by weight. In the case the surface treatment amount is lower than 0.1% by weight, at the time of drying and powdering, secondary agglomerates are formed among untreated faces to result in inferior dispersion. On the other hand, if it exceeds 50% by weight, adverse effects such as surface treatment agent isolation owing to the excess of the surface treatment agent and thermal stability deterioration on resin may possibly be caused.

The surface treatment agent to be used is not particularly limited and generally, a water-soluble surfactant, a water-soluble stabilizer, or a surface improvement agent may be used.

Examples of the water-soluble surfactant are carboxylic acid type polymers such as maleic acid-olefin (4 to 8 carbon atoms) copolymer salts (salts of alkali metals such as sodium and potassium, ammonium salt), maleic acid-styrene copolymer salts (salts of alkali metals such as sodium and potassium, ammonium salt); polymers (oligomers) such as poly(sodium styrenesulfonate); polycondensates such as sodium naphthalenesulfonate-formalin condensates, sodium alkylnaphthalenesulfonate-formalin condensates, and sodium melaminesulfonate-formalin condensates; natural products such as sodium ligninsulfonate (its derivatives); carboxylic acid polymers and polycarboxylic acid salts (salts of alkali metals such as sodium and potassium, ammonium salt) such as polyacrylic acid salts (salts of alkali metals such as sodium and potassium, ammonium salt), acrylic acid-maleic acid copolymer salts (salts of alkali metals such as sodium and potassium, ammonium salt); condensation type inorganic materials such as sodium tripolyphosphate and sodium hexametaphosphate; and also common anionic surfactants, cationic surfactants, and nonionic surfactants represented by polyglycerin fatty acid esters (with 8 or higher HLB) and sucrose fatty acid esters.

Examples of the water-soluble stabilizer are natural type or semi-synthesized water-soluble polymers such as processed starch, CMC, HEC, MC, HPC, gelatin, pullulans, alginic acid, guar gum, locust gum, xanthane gum, pectin, carrageenan, gum arabic, and ghatti gum; and synthetic type water-soluble polymers such as poly vinyl alcohol, acrylic acid type polymers, ethyleneimine type polymers, polyethylene oxides, polyacrylamides, polystyrenesulfonic acid salts, polyamidines, isoprene type sulfonic acid polymers.

Examples of the surface improvement agent are coupling agents such as silane coupling agents and titanate coupling agents; alicyclic carboxylic acids represented by naphthenic acid; resin acids represented by abietic acid, pimelic acid, palasitrinic acid, and neoabietic acid and modified rosin represented by their disproportionate rosin, hydrogenated rosin, dimer rosin, trimer rosin, organic acids such as acrylic acid, methacrylic acid, oxalic acid, and citric acid; saturated fatty acids represented by capric acid, lauric acid, myristic acid, palmitic acid, and stearic acid; unsaturated fatty acids represented by oleic acid, elaidic acid, linoleic acid, and ricinoleic acid; fibrin compounds, and siloxane compounds.

The above-mentioned surface treatment agent may be used singly or in combination of two or more. Among these surface treatment agents, particularly polyacrylic acid salts (salts of alkali metals such as sodium and potassium, ammonium salt etc.), polycarboxylic acid salts (salts of alkali metals such as sodium and potassium, ammonium salt etc.), sodium hexametaphosphate, polyglycerin fatty acid esters, and gum arabic are preferable for the dispersion stability and low viscosity of the calcium phosphate base particulate compound of the present invention.

The surface treatment method with the surface treatment agent is not particularly limited and in the case of wet treatment, the above-mentioned surface treatment agents may be mixed sufficiently with a water suspension containing a prescribed amount of the calcium phosphate base particulate compound with stirring force or a concentration with which stirring can be carried out evenly. Further, a preparation method for further improving the dispersibility of the particles by mechanical wet dispersion treatment can also be employed. As a wet dispersion treatment apparatus, a wet pulversizer, a high pressure emulsion dispersing apparatus, and an ultrasonic dispersion apparatus or the like can be employed. In the case of powdering after surface treatment, drying and powdering is carried out using a spraying drier or a box type drier, so that the calcium phosphate base particulate compound, which is an aim of the present invention, can be produced.

In the case of dry treatment, a Henshel mixer, a tumbler mixer, a planetary mixer, a kneader or the like is used at the temperature of the melting point or higher of the above-mentioned surface treatment agent to produce the calcium phosphate base particulate compound of the present invention.

The calcium phosphate base particulate compound of the present invention obtained in such a manner is suitably usable for various kinds of resins and used for resins for molding such as films, and resins for paper manufacturing such as ink-adsorption layer coatings. For example, in the case of addition to resins for films, the particulate compound provides anti-blocking and optical light scattering effects on thin base film resins and gives resins for films excellent in adhesion property and transparency.

The resins for molding are not particularly limited and practical examples are widely used resins represented by polyethylene (PE), polyvinyl chloride (PVC), polypropylene (PP), polystyrene (PS), ethylene-vinyl alcohol copolymer (EVOH), ABS, AS, acrylic polymers (PMMA), polyvinyl alcohol (PVA), polyvinylidene chloride (PVDC), and polyethylene terephthalate (PET); widely used engineering plastics represented by polyamide (PA), polyacrylonitrile (PAN), polyacetal (POM), polycarbonate (PC), polybutylene terephthalate (PBT), polyethylene naphthalate (PEN), polybutylene phthalate (PBN), and polytrimethylene terephthalate (PTT); super-engineering plastics represented by polyphenylene sulfide (PPS), polyamideimide (PAI), polyether imide (PEI), polyimide (PI), aramid, polyether ether ketone (PEEK), polysulfone (PSF), polyether sulfone (PES), polyarylate (PAR), liquid crystal polymer (LCP), and fluorocarbon resin (FR); thermosetting resins represented by phenolic resin, melamine resin, epoxy resin, polyurethane resin, and silicone resin; biodegradable and semi-synthetic resins (PBS type, PBSA type, PCL type, PLA type, PCL type, and cellulose type). These polymers and resins may be use singly or in combination of two or more. Among them, addition of the calcium phosphate base particulate compound of the present invention causes significant effects on anti-blocking property particularly in the case of polyolefins and saturated polyester resins and on optical light scattering property in the case of resins such as PC, PMMA, and semi-synthetic resin with high transparency.

The mixing ratio of the calcium phosphate base particulate compound of the present invention and a resin for molding is not particularly limited and may properly be determined based on the desired physical property, and it is generally 0.01 to 10 parts by weight, preferably 0.05 to 5 parts by weight of the calcium phosphate base particulate compound to 100 parts by weight of the resin. Based on the necessity, various kinds of additives such as a stabilizer may be added.

In the case the calcium phosphate base particulate compound of the present invention is added to a resin for paper manufacturing, as compared with the case of addition of a conventional calcium phosphate, a composition excellent in ink absorption property and resolution degree can be obtained. The resin for paper manufacturing is not particularly limited, resins which are soluble in water, dispersible in water, and dispersible in solvents such as alcohols can be exemplified. Further, examples of the resin may include PVA and its modified polymers (cationic modified polymer, anionic modified polymer, silanol-modified polymer); starch and its modified compounds (oxidized or etherified compounds); gelatin and its modified compounds; casein and its modified compounds; cellulose derivatives such as carboxymethyl cellulose, gum arabic, hydroxyethyl cellulose, and hydroxypropyl methyl cellulose; conjugated diene type copolymer latexes such as SBR latex, NBR latex, and methyl methacrylate-butadiene copolymer; functional group-modified polymer latexes; vinyl type copolymer latexes such as ethylene-vinyl acetate copolymers; polyvinylpyrrolidone; maleic anhydride and its copolymers; and acrylic acid ester copolymers and they may be used singly or in combination of two or more.

The mixing ratio of the calcium phosphate base particulate compound of the present invention and the resin for paper manufacturing is not particularly limited and may properly be determined based on the desired physical property and it is generally 10 to 1,000 parts by weight, preferably 50 to 500 parts by weight, of the calcium phosphate base particulate compound to 100 parts by weight of the resin. Based on the necessity, various kinds of additives such as a stabilizer may be added.

With respect to the resin composition of the present invention, other than the calcium phosphate base particulate compound of the present invention, to adjust the viscosity and other physical properties, inorganic fillers such as colloidal calcium carbonate, heavy calcium carbonate, colloidal silica, titanium oxide (rutile, anatase), talc, kaolin, zeolite, resin balloon, and glass balloon; plasticizers such as dioctyl phthalate and dibutyl phthalate; solvents for example, petroleum type solvents such as toluene and xylene; ketones such as acetone, methyl ethyl ketone; ether esters such as cellosolve acetate; silicone oils and fatty acid ester-modified silicone oils; and further, based on the necessity, one or more of various kinds of additives, coloring agents and the like may be added in combination.

In the case the calcium phosphate base particulate compound of the present invention is added to a composition for food products, the compound exhibits a function as a calcium enrichment agent and may be added to liquid type food products such as milk, processed milk, milk beverage, juice, coffee, tea, and cream; alcohol beverage such as wine and liquor; and food products such as cooked rice, pudding, jelly, yoghurt, candy, snack candy, bread, and noodle and the composition for food products excellent in taste can be obtained.

The mixing ratio of the calcium phosphate base particulate compound of the present invention and a food product is not particularly limited and may properly be determined based on the desired physical property and it is generally 0.01 to 5 parts by weight, preferably 0.1 to 1 part by weight, of the calcium phosphate base particulate compound to 100 parts by weight of the food products. Based on the necessity, the composition may contain one or more additives among various kinds of additives such as polyglycerin fatty acid ester, gum arabic, processed starch, sucrose fatty acid ester, carboxymethyl cellulose, methylcellulose, alginic acid propylene glycol ester, water-soluble soybean polysaccharide, condensed phosphoric acid salts, ghatti gum, phospholipid, and arabinogalactan.

As other composition components, other emulsifiers, organic acids, amino acids, colorants, spices, and seasonings may also be added.

The particulate compound may be used in combination with hardly water-soluble calcium salts and dispersions such as calcium carbonate and calcium phosphate; water-soluble calcium salts such as calcium lactate and calcium chloride and/or water-soluble magnesium salts such as magnesium chloride and magnesium sulfate.

Hereinafter, the present invention will be described in more detail with reference to Examples and Comparative Examples; however it is not intended that the present invention be limited to exemplified Examples.

### EXAMPLE 1

To adjust Ca/P ratio=1.67, a 10 wt. % aqueous calcium chloride solution (calcium ion solution) 200 kg was prepared in a tank, a 10 wt. % aqueous secondary sodium phosphate solution (phosphate ion solution) 153 kg was prepared in a tank, and also, a 24 wt. % aqueous sodium hydroxide solution for phosphorylation and pH adjustment was prepared.

Both of the calcium chloride solution and the secondary sodium phosphate solution were adjusted at 30° C. The secondary sodium phosphate solution was dropped at a flow rate of 153 kg/30 minute dropping time and the sodium hydroxide was dropped so as to keep pH in a range of 6.5 to 7.5 and phosphorylation reaction was carried out under the stirring condition at a stirring blade peripheral speed of 3 m/s. After 31 minutes from the starting of dropping, each dropping of the secondary sodium phosphate solution and sodium hydroxide was finished.

On completion of the dropping, the resulting reaction suspension was aged for 5 hours as it was. The pH after aging was 6.2.

Next, the reaction suspension concentration was adjusted to 5.0% by weight, the suspension was heated at 150° C. (0.5 MPa) for 12 hours at a stirring blade peripheral speed 1 m/s.

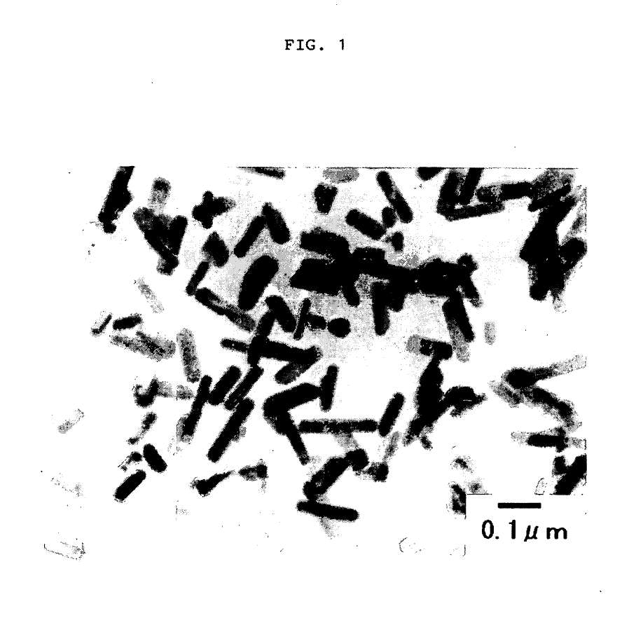

The calcium phosphate water suspension obtained in such a manner was washed with water by a membrane washing apparatus (Rotosep, manufactured by Shinko Pantec Co., Ltd.) and since the electric conductivity of washing water reached equilibrium at 150 μS/cm, which was the electric conductivity of the tap water, the washing with water was finished and the suspension was concentrated to 30% by weight in solid matter concentration. Poly sodium acrylate (T-40, manufactured by Toagosei Co., Ltd.), which is a water-soluble surfactant, was added in an amount of 5% by weight on the basis of the concentrated solid matter to the concentrated suspension and after being stirred, the resulting suspension was spray-dried by a spray drier to obtain a powder of calcium phosphate base particulate compound. The respective physical properties of the obtained powder and production conditions are shown in Table 1. In addition, FIG. 1 is a TEM photograph of the obtained powder.

### EXAMPLE 2

A powder of calcium phosphate base particulate compound was obtained in the same manner as that of Example 1, except that the respective concentrations of the aqueous calcium chloride solution and the secondary sodium phosphate solution were changed to 30% by weight and the surface treatment agent was changed to a polycarboxylic acid type surfactant (AKM-0531, manufactured by NOF Corporation). The respective physical properties of the obtained powder and production conditions are shown in Table 1.

### EXAMPLE 3

A powder of calcium phosphate base particulate compound was obtained in the same manner as that of Example 1, except that the phosphoric acid source was changed to secondary potassium phosphate: the respective concentrations of the aqueous calcium chloride solution and the secondary potassium phosphate solution were changed to 30% by weight: the reaction temperature was changed to 20° C.: the dropping time was changed to 25 minutes: and the pH at the time of phosphorylation was changed to 7 to 8. The respective physical properties of the obtained powder and production conditions are shown in Table 1.

### EXAMPLE 4

A powder of calcium phosphate base particulate compound was obtained in the same manner as that of Example 1, except that the reaction temperature was changed to 70° C. The respective physical properties of the obtained powder and production conditions are shown in Table 1.

### EXAMPLE 5

A powder of calcium phosphate base particulate compound was obtained in the same manner as that of Example 1, except that the dropping time was changed to 120 minutes. The respective physical properties of the obtained powder and production conditions are shown in Table 1.

### EXAMPLE 6

A powder of calcium phosphate base particulate compound was obtained in the same manner as that of Example 1, except that the phosphoric acid source was changed to tertiary sodium phosphate and the pH at the time of phosphorylation was changed to 10 to 11. The respective physical properties of the obtained powder and production conditions are shown in Table 1.

### EXAMPLE 7

A powder of calcium phosphate base particulate compound was obtained in the same manner as that of Example 1, except that the aging time was changed to 0.1 hours. The respective physical properties of the obtained powder and production conditions are shown in Table 1.

### EXAMPLE 8

A powder of calcium phosphate base particulate compound was obtained in the same manner as that of Example 1, except that the heating treatment temperature was changed to 120° C. The respective physical properties of the obtained powder and production conditions are shown in Table 1.

### EXAMPLE 9

A powder of calcium phosphate base particulate compound was obtained in the same manner as that of Example 1, except that as a complex forming substance, citric anhydride 5% by weight was added to the aqueous calcium chloride solution. The respective physical properties of the obtained powder and production conditions are shown in Table 1.

### EXAMPLE 10

A powder of calcium phosphate base particulate compound was obtained in the same manner as that of Example 2, except that the surface treatment agent was changed to gum arabic for the surface treatment. The respective physical properties of the obtained powder and production conditions are shown in Table 1.

TABLE 1

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| (a) Sw (m²/g) | 46 | 35 | 153 | 26 | 28 | 43 | 51 | 67 | 120 | 35 |
| (b) Tg (mg/g) | 35 | 29 | 66 | 84 | 33 | 82 | 42 | 68 | 88 | 29 |
| (c) Dx50 (μm) | 0.15 | 0.20 | 0.04 | 0.42 | 0.28 | 0.12 | 0.13 | 0.09 | 0.05 | 0.20 |
| (d) Dx50/σx | 5.5 | 5.0 | 7.5 | 2.0 | 6.5 | 6.5 | 2.8 | 8.5 | 8.6 | 5.0 |
| (e) α (dispersibility of particles) | 1.0 | 1.0 | 5.8 | 5.1 | 1.4 | 1.6 | 1.5 | 3.5 | 1.2 | 0.8 |
| (f) β (uniformity of particles) | 1.8 | 1.9 | 2.8 | 3.2 | 2.4 | 2.2 | 2.7 | 2.0 | 2.4 | 1.9 |
| Chlorine ion (ppm) | 300 | 400 | 100 | 50 | 500 | <5 | 800 | 2000 | 12000 | 300 |
| (g) Dxp (μm) | 0.031 | 0.059 | 0.013 | 0.16 | 0.078 | 0.018 | 0.048 | 0.022 | 0.016 | 0.059 |
| (h) Dyp/Dxp | 53 | 76 | 65 | 26 | 82 | 45 | 46 | 33 | 76 | 76 |
| Crystal form | hydroxyapatite | hydroxyapatite | hydroxyapatite | calcium hydrogen | hydroxyapatite | hydroxyapatite | hydraxyapatite | hydroxyapatite | hydroxyapatite | hydroxyapatite |
| | | | | phosphate | | calcium | | | | |
| | | | | octacalcium | | diphosphate | | | | |
| | | | | phosphate | | | | | | |
| Ca/P | 1.67 | 1.67 | 1.69 | 1.45 | 1.67 | 1.55 | 1.62 | 1.65 | 1.72 | 1.67 |
| Particle shape | pillar | pillar | pillar | plate | pillar | pillar | pillar | pillar | pillar | pillar |
| | (aspect | (aspect | (aspect | (aspect | (aspect | (aspect | (aspect | (aspect | (aspect | (aspect |
| | ratio = 5) | ratio = 10) | ratio = 2.0) | ratio = 10) | ratio = 5) | ratio = 5) | ratio = 4) | ratio = 4) | ratio = 5) | ratio = 10) |
| (1) Ca conc. (wt %) | 10 | 3 | 30 | 10 | 10 | 10 | 10 | 10 | 10 | 3 |
| Kind of Ca compound | CaCl₂ | CaCl₂ | CaCl₂ | CaCl₂ | CaCl₂ | Ca(NO₃)₂ | CaCl₂ | CaCl₂ | CaCl₂ | CaCl₂ |
| Complex forming substance | — | — | — | — | — | — | — | — | citric acid | — |
| Amount (wt %) | — | — | — | — | — | — | — | — | 5 | — |
| (2) Phosphorus conc. (wt %) | 10 | 3 | 30 | 10 | 10 | 10 | 10 | 10 | 10 | 3 |
| Kind of phosphoric acid compound | Na₂HPO₄ | Na₂HPO₄ | K₂HPO₄ | Na₂HPO₄ | Na₂HPO₄ | (NH₄)₂HPO₄ | Na₂HPO₄ | Na₂HPO₄ | Na₂HPO₄ | Na₂HPO₄ |
| (3) Reaction temperature (° C.) | 30 | 30 | 20 | 70 | 30 | 30 | 30 | 30 | 30 | 30 |
| (4) Dropping time (min) | 30 | 30 | 25 | 30 | 120 | 30 | 30 | 30 | 30 | 30 |
| (5) Stirring blade peripheral speed (m/s) | 3 | 3 | 3 | 3 | 3 | 3 | 3 | 3 | 3 | 3 |
| (6) pH at phosphorylation | 6.5-7.5 | 6.5-7.5 | 7.0-8.0 | 6.5-7.5 | 6.5-7.5 | 6.5-7.5 | 6.5-7.5 | 6.5-7.5 | 6.5-7.5 | 6.5-7.5 |
| (7) Aging time (hr) | 5 | 5 | 5 | 5 | 5 | 5 | 0.1 | 5 | 5 | 5 |
| (8) Calcium phosphate conc. (%) | 5.0 | 1.5 | 15 | 5.0 | 5.0 | 5.0 | 5.0 | 5.0 | 5.0 | 1.5 |
| (9) Heating treatment temp. (° C.) | 150 | 150 | 150 | 150 | 150 | 150 | 150 | 120 | 150 | 150 |
| (10) Heating treatment pH | 6.2 | 6.1 | 6.1 | 6.2 | 6.4 | 6.1 | 6.5 | 6.2 | 6.2 | 6.1 |
| (11) Heating treatment time (hr) | 12 | 12 | 15 | 12 | 12 | 12 | 12 | 12 | 12 | 12 |
| (12) Stirring blade peripheral speed (m/s) | 1 | 1 | 1 | 1 | 1 | 1 | 1 | 1 | 1 | 1 |
| Washing filtrate conductivity (μS/cm) | 150 | 150 | 150 | 150 | 150 | 150 | 150 | 150 | 1000 | 150 |
| Surface treatment agent | poly sodium | polycarboxylic | poly sodium | poly sodium | poly sodium | poly sodium | poly sodium | poly sodium | poly sodium | gum arabic |
| | acrylate | acid type | acrylate | acrylate | acrylate | acrylat | acrylate | acrylate | acrylate | |
| Surface treated amount (wt %) | 5 | 5 | 5 | 5 | 5 | 5 | 5 | 5 | 5 | 5 |

### COMPARATIVE EXAMPLE 1

As described in Example 8 of Japanese Patent Application Laid-Open No. 9-25108, an 8 wt. % calcium carbonate (manufactured by Maruo Calcium Co., Ltd.) suspension and a 5 wt. % phosphoric acid solution were prepared.

Both of the calcium carbonate suspension and the phosphoric acid solution were adjusted at 27° C. The phosphoric acid solution was dropped at a Ca/P=1.67 ratio while maintaing pH in a range of 6.5 to 7.0 to the calcium carbonate suspension and phosphorylation reaction was carried out under the stirring condition at 6.0 m/s stirring blade peripheral speed. Dropping was finished after 150 minutes from the starting of dropping. On completion of the dropping, the resulting reaction suspension was adjusted to have a concentration 1.7% by weight and then aged for 24 hours.

The calcium phosphate water suspension produced in the above-mentioned manner was concentrated to 8% by weight in solid matter concentration by a centrifugal dewatering apparatus. Poly sodium acrylate (T-40, manufactured by Toagosei Co., Ltd.), which is a water-soluble surfactant, was added in an amount of 5% by weight on the basis of the concentrated solid matter to the concentrated suspension and after being stirred, the resulting suspension was spray-dried by a spray drier to obtain a powder of calcium phosphate base particulate compound. The respective physical properties of the obtained powder and production conditions are shown in Table 2.

### COMPARATIVE EXAMPLE 2

A powder was obtained in the same production method as that of Example 1, except that sodium hydroxide used for phosphorylation and pH adjustment was not used. The respective physical properties of the obtained powder and production conditions are shown in Table 2.

### COMPARATIVE EXAMPLE 3

A water suspension of 30% by weight in solid matter concentration was prepared using commercialized colloidal hydroxyapatite (trade name; tertiary calcium phosphate; manufactured by Yoneyama Chemical Co., Ltd.).

Poly sodium acrylate (T-40, manufactured by Toagosei Co., Ltd.), which is a water-soluble surfactant, was added in an amount of 5% by weight on the basis of the calcium phosphate solid matter to the suspension and after being stirred, the resulting suspension was spray-dried by a spray drier to obtain a powder. The respective physical properties of the obtained powder and production conditions are shown in Table 2.

### COMPARATIVE EXAMPLE 4

As described in Example 2 of Japanese Patent Application Laid-Open No. 55-84327, the following raw materials were mixed by a high shearing force mixer (TK homo-mixer, manufactured by Tokushu Kika Kogyo Co., Ltd.) in the raw material order shown as the following table. The pH of the obtained mixture was 7.2.

| | | temperature | stirring |
|---|---|---|---|
| Raw material | addition amount (g) | (° C.) | time (min.) |
| water | 773.2 | | |
| calcium hydroxide | 3.7 | 27 | 5 |
| dipotassium phosphate | 11.2 | 30 | 5 |
| magnesium hydroxide | 1.9 | 29 | 5 |
| citric anhydride | 10.0 | 29 | 10 |

As a surface treatment agent, gum arabic was added in an amount of 5% by weight on the basis of the calcium phosphate solid matter to the obtained suspension and after being stirred, the suspension was spray-dried by a spray drier to obtain a powder. The respective physical properties of the obtained powder and production conditions are shown in Table 2.

### COMPARATIVE EXAMPLE 5

A water suspension of 30% by weight in solid matter concentration was prepared using commercialized colloidal hydroxyapatite (trade name; tertiary calcium phosphate; manufactured by Yoneyama Chemical Co., Ltd.).

Gum arabic was added in an amount of 5% by weight on the basis of the calcium phosphate solid matter to the suspension and after being stirred, the resulting suspension was spray-dried by a spray drier to obtain a powder. The respective physical properties of the obtained powder and production conditions are shown in Table 2.

TABLE 2

| | Comp. Ex. 1 | Comp. Ex. 2 | Comp. Ex. 3 | Comp. Ex. 4 | Comp. Ex. 5 |
|---|---|---|---|---|---|
| (a) Sw (m²/g) | 180 | 0.4 | 38 | 95 | 38 |
| (b) Tg (mg/g) | 155 | 84 | 45 | 350 | 31 |
| (c) Dx50 (μm) | 1.7 | 28 | 0.08 | 0.05 | 0.08 |
| (d) Dx50/σx | 5.7 | 3.7 | 0.4 | 3.8 | 0.4 |
| (e) α (dispersibility of particles) | 1.3 | 1.5 | 61 | 1.8 | 61 |
| (f) β (uniformity of particles) | 0.7 | 3.3 | 14.8 | 3.1 | 14.8 |
| Chlorine ion (ppm) | 5< | 60 | 5< | 5< | 5< |
| (g) Dxp (μm) | 0.53 | 17 | 0.05 | 0.01 | 0.05 |
| (h) Dyp/Dxp | 11 | 250 | 17 | 95 | 17 |
| Crystal form | hydroxyapatite | calcium hydrogen | hydroxyapatite | tricalcium phosphate hydrate- | hydroxyapatite |
| | | phosphate | | potassium citrate composite | |
| Ca/P | 1.67 | 1.05 | 1.67 | 1.96 | 1.05 |
| Particle shape | petaloid | plate | bulk | rod | bulk |
| | (porous) | | | (aspect ratio = 7) | |
| (1) Ca conc. (wt %) | 8 | 10 | | — | |
| Kind of Ca compound | — | CaCl₂ | | — | |
| Complex forming substance | — | — | | — | |
| Amount (wt %) | — | — | | — | |
| (2) Phosphorus conc. (wt %) | 5 | 10 | | — | |
| Kind of phosphoric acid compound | H₃PO₄ | NaH₂PO₄ | | — | |
| (3) Reaction temperature (° C.) | 27 | 30 | | — | |
| (4) Dropping time (min) | 150 | 30 | commercialized | — | commercialized |
| (5) Stirring blade peripheral speed (m/s) | 6 | 3 | hydroxyapatite | — | hydroxyapatite |
| (6) pH at phosphorylation | 6.5-7.5 | 6.5-7.5 | | — | |
| (7) Aging time (hr) | 5 | 5 | | — | |
| (8) Calcium phosphate conc. (%) | 1.7 | 4.5 | | — | |
| (9) Heating treatment temp. (° C.) | 27 | 150 | | — | |
| (10) Heating treatment pH | 7.5-8.5 | 4.8 | | — | |
| (11) Heating treatment time (hr) | 24 | 12 | | — | |
| (12) Stirring blade peripheral speed (m/s) | 6 | 1 | | — | |
| Washing filtrate conductivity (μS/cm) | 150 | 150 | | — | |
| Surface treatment agent | poly sodium | poly sodium | poly sodium | gum arabic | gum arabic |
| | acrylate | acrylate | acrylate | | |
| Surface treated amount (wt %) | 5 | 5 | 5 | 10 | 5 |

### EXAMPLES 11 TO 19 AND COMPARATIVE EXAMPLES 6 TO 8

Using the powders produced in Examples 1 to 9 and Comparative Examples 1 to 3, resin compositions for films were produced by the following methods. Evaluation of the obtained resin compositions for films is shown in Table 3.

<Film Production>

Dimethyl terephthalate and ethylene glycol were polymerized by a common method using magnesium acetate as an ester interchange catalyst, titanium trimellitate as a polymerization catalyst, phosphorous acid as a stabilizer; and each powder of Examples 1 to 9 and Comparative Examples 1 to 3 as an anti-blocking agent to obtain polyethylene terephthalate (PET) resin.

After each obtained resin was dried at 170° C. for 3 hours, supplied to an extruder, melted at a melting temperature of 280 to 300° C., subjected to high precision filtration with a steel wire filter with 11 μm meshes, and formed into a non-stretched film by a multi-manifold type extrusion die.

Each obtained non-stretched film was pre-heated, rolled between low speed and high speed rolls to be stretched 3.3 times vertically and 4.2 times transversely at a film temperature of 100° C. to finally obtain a biaxially-stretched film with 5 μm thickness.

Each obtained film was subjected to the measurements of the various properties by the following methods and evaluated.

<Blocking Separation Force by Corona Treatment>

Each sample cut in a rectangular shape of 10 cm in longitudinal direction and 20 cm in width direction of a roll film was corona-treated at a temperature of 25° C. and a humidity of 50%. The treatment was carried out in the following conditions using CG-102 model high frequency power source manufactured by Kasuga Denki.
Electric current: 4.5 A
Electrode distance: 1.0 mm
Treatment time: passing at 1.2 m/min speed between the electrodes

The treated film was aged in conditions of 100 kg/cm² pressure and 60° C.×80% RH for 17 hours immediately after treatment and then the separation force per 10 cm width was measured by a mechanical tensitometer.

<Number of Coarse Projections on Film Surface>

After aluminum was deposited in 0.5 μm thickness on the film surface, the surface was observed at 400 times magnification by a differential interference method using an optical microscope (POTIPHOT, manufactured by Nikon Co., Ltd.) and the projections with a size of 2 μm or more length and 5 μm or more width were counted and the number of the projections per 1 mm² was calculated by conversion and the evaluation was carried out based on the following standards.
⊚: 0 to 3 pieces
◯: 4 to 7 pieces
Δ: 8 to 11 pieces
X: 12 or more pieces
   <Magnetic Tape Production and Property Evaluation>

A ferromagnetic thin film of 100% cobalt was formed in two layers in total thickness of 0.2 μm (the thickness of the respective layers: about 0.1 μm) was formed on the biaxially oriented layered film surface by a vacuum evaporation method and a diamond-like carbon (DLC) film and a fluorocarboxylic acid type lubricant layer were successively formed on the surface and a back coat layer was formed on the rear face of the film by a known method. After that, the film was slit in 8 mm width and the tape properties were measured by the following commercialized appliance.

Appliance used: 8 mm video tape recorder (EDV-6000, manufactured Sony Corp.)

1) C/N Measurement (Noise Meter, Manufactured by ShibaSoku Co., Ltd.)

Signals with recording wavelength 0.5 μm (frequency 7.4 MHz) were recorded and the ratio of the regenerated signals at 6.4 MHz and 7.4 MHz was defined as the C/N of the tape and the C/N value of a commercialized 8 mm evaporation tape for video tape recording was standardized as 0 dB and evaluation was carried out according to the following standards.
⊚: +6 dB or higher as compared with that of the commercialized 8 mm tape
◯: +3 dB or higher and lower than +6 dB as compared with that of the commercialized 8 mm tape
Δ: +1 dB or higher and lower than +3 dB as compared with that of the commercialized 8 mm tape
X: lower than +1 dB as compared with that of the commercialized 8 mm tape
   2) Drop Out (Drop Out Counter, Manufactured by ShibaSoku Co., Ltd.)

Drop out of 3 μsec/10 dB or longer was counted for 10 minutes and the number of the drop out per 1 minute was calculated and evaluation was carried out according to the following standards.
⊚: less than 5 times drop out/min.
◯: 5 to 10 times drop out/min.
Δ: 10 to 15 times drop out/min.
X: not less than 16 times drop out/min.
   3) Running Durability

Image signals of 4.2 MHz were recording in the above-mentioned evaporation tape and output alteration was investigated after repeating tape running including unreeling at 41 m/min speed and reeling at 41 m/min speed for 1 time running under 25° C. and 50% RH conditions in total 200 times. Based on the output alteration, evaluation was carried out according to the following standards.
⊚: 0 dB to −0.3 dB output alteration after repeating 200 times
◯: 0 dB to −0.6 dB output alteration after repeating 200 times
Δ: 0 dB to −0.9 dB output alteration after repeating 200 times
X: −1 dB or lower output alteration after repeating 200 times

As being made clear from the results of Table 3, the resin compositions for films containing the calcium phosphate base particulate compounds of the present invention were found excellent in corona treatment anti-blocking and even in the case of use for evaporated metal film type recording media, the resin compositions showed good running durability, excellent electromagnetic conversion properties and scarce drop out.

TABLE 3

| | | Blocking separation | | | | |
|---|---|---|---|---|---|---|
| | | force by corona | Number of | | | |
| | Ex. or Comp. Ex. | treatment. | coarse | C/N | | Running |
| | of particles used | (g/10 cm) | projections | measurement | Drop out | durability |
| Ex. 11 | Ex. 1 | 8 | ⊚ | ◯ | ◯ | ◯ |
| Ex. 12 | Ex. 2 | 9 | ⊚ | ◯ | ⊚ | ⊚ |
| Ex. 13 | Ex. 3 | 16 | Δ | Δ | Δ | Δ |
| Ex. 14 | Ex. 4 | 17 | Δ | Δ | Δ | Δ |
| Ex. 15 | Ex. 5 | 13 | ◯ | ◯ | ◯ | ◯ |
| Ex. 16 | Ex. 6 | 11 | Δ | Δ | Δ | Δ |
| Ex. 17 | Ex. 7 | 14 | ◯ | ◯ | ◯ | ◯ |
| Ex. 18 | Ex. 8 | 16 | ◯ | Δ | ⊚ | ◯ |
| Ex. 19 | Ex. 9 | 11 | ◯ | Δ | Δ | Δ |
| Comp. Ex. 6 | Comp. Ex. 1 | 15 | Δ | X | X | X |
| Comp. Ex. 7 | Comp. Ex. 2 | break | X | X | X | X |
| Comp. Ex. 8 | Comp. Ex. 3 | break | X | X | X | X |

### EXAMPLES 20 TO 28 AND COMPARATIVE EXAMPLES 9 TO 11

The respective powders produced in Examples 1 to 9 and Comparative Examples 1 to 3 were dispersed as reception layer materials to produce resin compositions for sublimation type thermal transfer films from the following components. Each of the obtained resin compositions was applied in 10 μm dry thickness on a polyester film and dried and evaluation of the obtained resin compositions for sublimation type thermal transfer films is shown in Table 4.

(Production of Film for Reception Layer)

| | |
|---|---|
| Each sample (each powder of Examples 1 to 9 and | 5 parts by weight |
| Comparative Examples 1 to 3) | |
| Polyester | 5 parts by weight |
| Ethyl acetate | 10 parts by weight |
| Toluene | 10 parts by weight |

1) State at the Time of Film Production

Whether film formation could stably be carried out without blocking or not was judged by eye observation.

2) Evaluation of Image Density (Printing Unevenness)

Using each thermal transfer reception layer sheet cut in A6 size, a commercialized sublimation transfer ink ribbon (Print Set P-PS100 for printers manufactured by Caravelle Data System Co., Ltd.), and a commercialized printer (thermal transfer type label printer BLP-323, manufactured Bon Electric Co., Ltd.), printing was carried out at printing speed 100 mm/s and head voltage 18V. The image density was evaluated by eye observation according to the following standards.

⊚: An extremely clear image was observed without density unevenness, printing scratches and omission.

◯: A clear image was observed although having very slight density unevenness, printing scratches and omission.

Δ: A good image was observed although having slight density unevenness, printing scratches and omission.

X: Density unevenness, printing scratches and omission were observed and no clear image was obtained.

3) Wrinkle Evaluation

Using each sheet evaluated in 2), occurrence of wrinkling was evaluated by eye observation according to the following standards.

⊚: No wrinkle was formed.

◯: Very slight wrinkling occurred.

Δ: Slight wrinkling occurred.

X: Wrinkling was observed clearly.

As being made clear from Table 4, the resin compositions for thermal transfer films containing the calcium phosphate base particulate compounds of the present invention were found good with little printing unevenness and wrinkling.

TABLE 4

| | Ex. or | | Image | |
|---|---|---|---|---|
| | Comp. Ex. | | density | |
| | of particles | State at | (printing | |
| | used | film production | unevenness) | Wrinkling |
| Ex. 20 | Ex. 1 | stable | ⊚ | ⊚ |
| Ex. 21 | Ex. 2 | stable | ◯ | ⊚ |
| Ex. 22 | Ex. 3 | single break | ◯ | Δ |
| Ex. 23 | Ex. 4 | single break | Δ | Δ |
| Ex. 24 | Ex. 5 | stable | Δ | ◯ |
| Ex. 25 | Ex. 6 | stable | ◯ | Δ |
| Ex. 26 | Ex. 7 | single break | ◯ | Δ |
| Ex. 27 | Ex. 8 | stable | Δ | Δ |
| Ex. 28 | Ex. 9 | stable | Δ | Δ |
| Comp. Ex. 9 | Comp. Ex. 1 | frequent break | X | Δ |
| Comp. Ex. 10 | Comp. Ex. 2 | frequent break | — | — |
| | | incapable | | |
| | | filming | | |
| Comp. Ex. 11 | Comp. Ex. 3 | frequent break | X | X |

### EXAMPLES 29 TO 31 AND COMPARATIVE EXAMPLES 12 TO 14

Using the powders produced in Examples 1 to 3 and Comparative Examples 1 to 3, reflection preventive resin compositions for liquid crystal display were produced from the following components. Compositions containing no powder of Examples and Comparative Examples were used as blanks. The results of property evaluation of the obtained resin are shown in Table 5.

(Production of Reflection Preventive Film)

(Blending of Coating Solution for Antiglare Layer Formation)

| | |
|---|---|
| Urethane acrylate type UV-setting type resin | 100 parts by weight |
| UV polymerization initiator | 5 parts by weight |
| Toluene solvent | 500 parts by weight |

(Blending of Reflection Prevention Agent)

| | |
|---|---|
| Each sample (each powder of Examples 1 to 3 and | 1 part by weight |
| Comparative Examples 1 to 3) | |
| Tridecafluorohexyltriethoxysilane | 50 parts by weight |
| Ethanol | 500 parts by weight |

The above-mentioned coating solution for antiglare layer formation was applied to one face of a triacetyl cellulose film (a transparent material film) with 100 μm thickness by a bar coater, dried for solvent removal, and cured by UV radiation to form an antiglare layer with 3 μm thickness. The reflection prevention agent was applied to the antiglare layer in a manner that the average thickness became about 100 nm at the time of drying and curing to obtain a reflection preventing film.

<Evaluation of Reflection Prevention Film>

1) Mirror Face Reflectivity: Y Value

UV-2400 manufactured by Shimadzu Corporation was used. As the reflectivity was lower, the visibility of the display face was higher.

2) Total Light Transmittance: %

A haze meter HGM-2DP manufactured by Suga Test Instruments Co., Ltd. was used.

3) Dust Adhesion

Small pieces of paper with about 1 mm square were scattered on the reflection prevention layer face of each reflection prevention film and the adhesion property was evaluation according to the following standards.

◯: Less than 5 pieces of paper adhered.

Δ: Not less than 5 and less than 10 pieces of paper adhered.

X: Not less than 10 pieces of paper adhered.

As being made clear from the results of Table 5, the resin compositions for (reflection prevention) films containing the calcium phosphate base particulate compounds of the present invention were found good in display visibility and scarcein dust adhesive property.

TABLE 5

| | Ex. or | | | |
|---|---|---|---|---|
| | Comp. Ex. | Mirror face | Total light | |
| | of particles | reflectivity: | transmittance | Dust |
| | used | Y value (%) | (%) | adhesion |
| Ex. 29 | Ex. 1 | 2.4 | 91 | ◯ |
| Ex. 30 | Ex. 2 | 1.9 | 92 | ◯ |
| Ex. 31 | Ex. 3 | 2.8 | 89 | Δ |
| Comp. Ex. 12 | Comp. Ex. 1 | 3.2 | 90 | X |
| Comp. Ex. 13 | Comp. Ex. 2 | 4.5 | 92 | X |
| Comp. Ex. 14 | Comp. Ex. 3 | 3.8 | 83 | X |
| Blank | — | 1.8 | 93 | X |

### EXAMPLES 35 TO 37 AND COMPARATIVE EXAMPLES 15 TO 17

Using the powders produced in Examples 1 to 3 and Comparative Examples 1 to 3, optical compensation resin film compositions for liquid crystal display were produced from the following components. Compositions containing no powder of Examples and Comparative Examples were used as blanks. The results of property evaluation of the obtained resin are shown in Table 6.

(Production of Optical Compensation Film)

(Blending of Film)
Polycarbonate resin 100 parts by weight
Each sample (each powder of Examples 1 to 3 and Comparative Examples 1 to 3) 5 parts by weight

Each sample was added to a commercialized polycarbonate, which is a polycondensate of bisphenol A and phosgene (Panlite C 1400, manufactured by Teijin Chemicals Ltd.) to form a film and stretched uniaxially at stretching temperature of 160° C. and 1.2 times expansion to obtain a half wavelength film.

Using the half wavelength film, an incoming side polarization film, a first half wavelength film, a second half wavelength film, and an outgoing side polarization film were laminated using an adhesive in this order while the polarization axis of the coming in side polarization film was set to be 0 degrees, the delay phase axis of the first half wavelength film was set to be 22.5 degrees, the delay phase axis of the second half wavelength film was set to be 67.5 degrees, and the polarization axis of the outgoing side polarization film was set to be 90 degrees. The transmission spectra of the laminated film (450 nm, 550 nm, and 700 nm) are shown in Table 6.

As being made clear from the results of Table 6, the resin compositions for (optical compensation) films containing the calcium phosphate base particulate compounds of the present invention were found stable and high in transmittance in the total wavelength region.

TABLE 6

| | Ex. or | | | |
|---|---|---|---|---|
| | Comp. Ex. | Measurement | Measurement | Measurement |
| | of particles | wavelength | wavelength | wavelength |
| | used | 400 nm | 550 nm | 700 nm |
| Ex. 35 | Ex. 1 | 95.8 | 96.0 | 95.9 |
| Ex. 36 | Ex. 2 | 96.1 | 96.3 | 96.2 |
| Ex. 37 | Ex. 3 | 95.1 | 95.4 | 95.2 |
| Comp. | Comp. Ex. 1 | 87 | 95.5 | 94.8 |
| Ex. 15 | | | | |
| Comp. | Comp. Ex. 2 | <80 | 95.4 | 93.8 |
| Ex. 16 | | | | |
| Comp. | Comp. Ex. 3 | 82 | 95.5 | 94.3 |
| Ex. 17 | | | | |
| Blank | — | <80 | 95.3 | 93.3 |

### EXAMPLES 38 TO 46 AND COMPARATIVE EXAMPLES 18 TO 20

Using the powders produced in Examples 1 to 9 and Comparative Examples 1 to 3, resin compositions (for ink absorption coating layer) for paper manufacturing were produced from the following components. The results of recording property evaluation are shown in Table 7.

(Raw Materials and Production Method)

| | |
|---|---|
| Each sample (each powder of Examples 1 to 9 and | 100 parts by weight |
| Comparative Examples 1 to 3) | |
| Poly(vinyl alcohol) | 45 parts by weight |
| Ammonium chloride | 5 parts by weight |
| Water | 300 parts by weight |

On the other hand, using high-quality paper with a basic weight of 701 m² as a substrate the above-mentioned coating composition was applied in a dry coating amount of 15 g/m² to the substrate by a blade coater and dried by a common method to obtain recording paper.

<Recording Property Evaluation>

1) Dot Shape Factor

Using a commercialized ink-jet printer (PM-930C manufactured by EPSON Co., Ltd.), monochromic dots of black ink were printed and to evaluate bleeding of the ink, the dot circumferential length and dot area were measured by an image analyzer (LUZEX 5000, manufactured by Nireco Corporation) to calculate the shape factor SF2. The shape factor SF2 is an index closer to 100 as the shape has higher circularity.

2) Evaluation of Ink Absorption Property and Clearness of Image

The bleeding of ink in the boundary portions of the monochromatic mat printed portion was judged by eye observation. The evaluation was graded in 4 ranks: ⊚, ◯, Δ, and X in better absorption property order.

3) Evaluation of Image Density

The portion where mat printing with black ink was carried out was measured by a reflection densitometer (Macbeth RD 918). As the numerical value was higher, the image density was higher and better. If the value was 1.40 or higher, the quality was regarded as good.

4) Evaluation of Coating Layer Strength

The ink reception layer surface was scratched with black cloth and the amout of the coating layer adhering to the black cloth was evaluated by eye observation according to the following standards.

⊚: Adhesion was not observed.

◯: Adhesion was very slightly observed.

Δ: Adhesion was slightly observed.

X: Adhesion was observed clearly.

5) Luster Impression

The luster impression was judged by eye observation from a transverse angle of 20° to the printed portion according to the following standards.

⊚: Luster impression was as high as the silver salt type color photograph.

◯: Luster impression was high although it was inferior to that of color photograph.

Δ: Luster impression was as same as coated paper printing.

X: Luster impression was as same as common PPC.

6) Overall Evaluation

The suitability as a delustering coating material was evaluated in the following 4 ranks as overall evaluation.
A: Preferable for recording paper
B: Relatively preferable for recording paper
C: Not so much preferable for recording paper
D: Not preferable for recording paper

As being made clear from the results of Table 7, the resin compositions for paper manufacturing containing the calcium phosphate base particulate compounds of the present invention were found good in ink absorption property even in the case of using a latest ink-jet printer, which has a high printing speed, and also good in the printed image density, coating layer strength, and luster impression.

TABLE 7

| | | | Ink absorption | | | | |
|---|---|---|---|---|---|---|---|
| | | | property and | | Coating | | |
| | Ex. or Comp. Ex. | Dot shape | clearness of | Image | layer | Luster | Overall |
| | of particles used | factor | image | density | strength | impression | evaluation |
| Ex. 38 | Ex. 1 | 110 | ◯ | 1.55 | ⊚ | ⊚ | A |
| Ex. 39 | Ex. 2 | 105 | Δ | 1.48 | ⊚ | ⊚ | A |
| Ex. 40 | Ex. 3 | 135 | ⊚ | 1.65 | Δ | Δ | B |
| Ex. 41 | Ex. 4 | 110 | Δ | 1.42 | Δ | Δ | B |
| Ex. 42 | Ex. 5 | 130 | Δ | 1.48 | ◯ | Δ | B |
| Ex. 43 | Ex. 6 | 120 | ◯ | 1.46 | Δ | ◯ | B |
| Ex. 44 | Ex. 7 | 115 | Δ | 1.49 | ◯ | ◯ | B |
| Ex. 45 | Ex. 8 | 130 | ◯ | 1.41 | ◯ | ◯ | B |
| Ex. 46 | Ex. 9 | 110 | ⊚ | 1.68 | ◯ | ⊚ | A |
| Comp. Ex. 18 | Comp. Ex. 1 | 120 | Δ | 1.31 | Δ | X | C |
| Comp. Ex. 19 | Comp. Ex. 2 | 1000> | X | 0.35 | X | X | D |
| Comp. Ex. 20 | Comp. Ex. 3 | 280 | X | 1.19 | X | X | D |

### EXAMPLE 47 AND COMPARATIVE EXAMPLES 21 TO 22

Using the powders produced in Example 10 and Comparative Examples 4 and 5, food additive test and food composition test were carried out according to the following methods. The results are shown in Table 8.

<Food Additive Test>

1) Precipitation Evaluation

After water dilution was carried out so as to adjust the mineral content to be 0.5% by weight, the diluted solution was put in a 100 ml messcylinder and kept still at 10° C. and the height alteration of the interface of the transparent part formed owing to the precipitation of the respective types of minerals and the colored part of the dispersion of the mineral was observed with the lapse of time and the amount of the precipitation was observed with lapse of time by eye observation to determine the stability in water for respective water dispersions. The scales per ml unit grooved in the messcylinder were read and evaluation was carried out according to the following standards.

(Interface Height)

⊚: Interface was at 95 ml or higher.

◯: Interface was at 90 ml or higher and lower than 95 ml.

Δ: Interface was at 80 ml or higher and lower than 90 ml.

X: Interface was lower than 80 ml.

(Precipitation Amount)

⊚: Precipitation scarcely observed.

◯: Precipitated mater slightly observed.

Δ: Precipitation of about less than 1 mm observed.

X: Precipitation of not less than 1 mm observed.

2) Property Evaluation of Calcium-Enriched Milk

Each sample was weighed so as to adjust the total amount of calcium to be 25 g and dissolved in butter 400 g melted at 60° C. and the melted butter was added to and stirred with de-fatted milk powder and pasteurized to obtain calcium-enriched milk 10 L. The obtained calcium-enriched milk was put in several 100 ml messcylinders and preserved at 5° C. and periodically calmly discarded out of the messcylinders and the alteration of the amount of the precipitate remaining in the bottom part of the messcylinders with the lapse of time were observed by eye observation. With respect to the calcium-enriched milk, 50 elder, young, and healthy men and women were selected as examiners and the average value of the taste was investigated.

(Precipitation Amount)

⊚: Precipitation scarcely observed.

◯: Precipitated matter very slightly observed.

Δ: Precipitated matter slightly observed.

X: A rather high quantity of precipitated matter observed.

(Taste)

5: good taste
4: not particularly noticeable with respect to taste
3: not unpleasant but noticeable with respect to taste
2: slightly unpleasant with respect to taste
1: unpleasant with respect to taste

As being made clear from the results of Table 8, the food compositions obtained by adding the calcium phosphate base particulate compounds of the present invention were found having no precipitation problem and giving good taste in actual drinking test.

TABLE 8

| | | | | Evaluation of calcium- | |
|---|---|---|---|---|---|
| | Ex. or Comp. Ex. | Precipitation evaluation | | enriched milk | |
| | of particles used | Interface height | Precipitation amount | Precipitation amount | Taste |
| Ex. 47 | Ex. 10 | ⊚ | ◯ | ◯ | 4.6 |
| Comp. Ex. 21 | Comp. Ex. 4 | ⊚ | ⊚ | ⊚ | 1.4 |
| Comp. Ex. 22 | Comp. Ex. 5 | X | X | Δ | 4.3 |

### INDUSTRIAL APPLICABILITY

As described above, the calcium phosphate base particulate compound of the present invention is excellent in particulate evenness and dispersibility and thermal stability, and in the case of addition to resins for films, the particulate compound gives a resin composition excellent in anti-blocking property and optical properties, and in the case of addition to resin for paper manufacturing, the particulate compound gives a resin composition excellent in printing suitability, and in the case of addition to food, the particulate compound hardly precipitates and gives a food composition such as calcium-enriched milk with good taste.

1. A calcium phosphate base particulate compound satisfying the following expressions (a) to (d):
20≦Sw≦300 (m²/g); (a)
1≦Tg≦150 (mg/g); (b)
0.005≦Dx50≦0.5 (μm); and (c)
1.5≦Dx50/σx≦20 (d)
wherein,
Sw: BET specific surface area (m²/g) measured by nitrogen adsorption method,
Tg: heat loss (mg/g) per 1 g of calcium phosphate base particulate compound from 250 to 500° C.,
Dx50: cumulative 50% average diameter (μm) counted from larger particle side based on the observation by transmission electron microscope (TEM),
σx: standard deviation {In(Dx16/Dx50)}; and
Dx16: cumulative 84% average diameter (μm) counted from larger particle side based on the observation by transmission electron microscope (TEM).

2. The calcium phosphate base particulate compound according to claim 1 further satisfying the following expressions (e) and (f):
0.5≦α≦5, wherein α=Dxs50/Dx50; and (e)
0≦β≦3, wherein β=(Dxs90−Dxs10)/Dxs50, (f)
wherein,
α: dispersion coefficient,
Dxs50: weight cumulative 50% average particle diameter (μm) counted from larger particle side in the particle size distribution measured by laser diffraction (SALD-2000, manufactured by Shimadzu Corporation),
β: sharpness,
Dxs90: weight cumulative 10% average particle diameter (μm) counted from larger particle side in the particle size distribution measured by laser diffraction (SALD-2000, manufactured by Shimadzu Corporation), and
Dxs10: weight cumulative 90% average particle diameter (μm) counted from larger particle side in the particle size distribution measured by laser diffraction (SALD-2000, manufactured by Shimadzu Corporation).

3. The calcium phosphate base particulate compound according to claim 2 further satisfying the following expressions (g) and (h):
0.005≦Dxp≦0.5 (μm); and (g)
20≦Dyp/Dxp≦200 (h)
wherein,
Dxp: average fine pore diameter (μm) with which the mercury pressure penetration increase amount (integrated fine pore volume increase/log(average fine pore diameter)) becomes the maximum value (Dys) in the fine pore distribution in a range of 0.005 to 0.5 μm measured by mercury pressure penetration method,
Dyp: maximum value of the mercury pressure penetration increase amount (mg/l), and
Dyp/Dxp: amount of the average fine pore diameter.

4. The calcium phosphate base particulate compound according to claim 3, wherein the crystal state of the calcium phosphate base particulate compound is mainly hydroxyapatite.

5. A production method of the calcium phosphate base particulate compound which comprises the steps of:
synthesizing calcium phosphate compound by reaction of a calcium compound and a water-soluble phosphoric acid compound in a pH range of 5 to 12,
aging the obtained calcium phosphate compound for 0.1 to 24 hours, and
heating the obtained calcium phosphate compound at 95 to 180° C.

6. A resin composition containing the calcium phosphate base particulate compound according to claim 1 in a resin.

7. The resin composition according to claim 6, wherein the resin is for films and 0.01 to 10 parts by weight of the calcium phosphate base particulate compound is added to 100 parts by weight of the resin.

8. The resin composition according to claim 6, wherein the resin is for paper manufacturing and 10 to 1,000 parts by weight of the calcium phosphate base particulate compound is added to 100 parts by weight of the resin.

9. A food composition containing the calcium phosphate base particulate compound according to claim 1 in a food product.

10. The food composition according to claim 9, wherein 0.01 to 5 parts by weight of the calcium phosphate base particulate compound is added to 100 parts by weight of the food product.

11. The calcium phosphate base particulate compound according to claim 1 further satisfying the following expressions (g) and (h):
0.005≦Dxp≦0.5 (μm); and (g)
20≦Dyp/Dxp≦200 (h)
wherein,
Dxp: average fine pore diameter (μm) with which the mercury pressure penetration increase amount (integrated fine pore volume increase/log(average fine pore diameter)) becomes the maximum value (Dys) in the fine pore distribution in a range of 0.005 to 0.5 μm measured by mercury pressure penetration method,
Dyp: maximum value of the mercury pressure penetration increase amount (mg/l), and
Dyp/Dxp: amount of the average fine pore diameter.

12. The calcium phosphate base particulate compound according to claim 11, wherein the crystal state of the calcium phosphate base particulate compound is mainly hydroxyapatite.

13. The calcium phosphate base particulate compound according to claim 1, wherein the crystal state of the calcium phosphate base particulate compound is mainly hydroxyapatite.

14. A resin composition containing the calcium phosphate base particulate compound according to claim 2 in a resin.

15. The resin composition according to claim 14, wherein the resin is for films and 0.01 to 10 parts by weight of the calcium phosphate base particulate compound is added to 100 parts by weight of the resin.

16. The resin composition according to claim 14, wherein the resin is for paper manufacturing and 10 to 1,000 parts by weight of the calcium phosphate base particulate compound is added to 100 parts by weight of the resin.

17. A food composition containing the calcium phosphate base particulate compound according to claim 2 in a food product.

18. The food composition according to claim 17, wherein 0.01 to 5 parts by weight of the calcium phosphate base particulate compound is added to 100 parts by weight of the food product.

19. A food composition containing the calcium phosphate base particulate compound according to claim 3 in a food product.

20. The food composition according to claim 19, wherein 0.01 to 5 parts by weight of the calcium phosphate base particulate compound is added to 100 parts by weight of the food product.
